(19) United States
(12) Patent Application Publication
(10) Pub. No.: US 2026/0245873 A1
(43) Pub. Date: Aug. 20, 2026

(54) METHOD OF FORMING A COMPOSITE STRUCTURE AND ALKALI METAL OR ALKALI EARTH METAL BATTERY COMPRISING SAID COMPOSITE STRUCTURE

(71) Applicant: Sumitomo Chemical Co., Ltd, Tokyo (JP)

(72) Inventors: Thomas Johannes Kugler, Godmanchester (GB); Paulina Librizzi, Godmanchester (GB); Konrad Zalewski, Godmanchester (GB)

(21) Appl. No.: 19/470,865

(22) PCT Filed: Mar. 20, 2024
(86) PCT No.: PCT/EP2024/057469

§ 371 Date: Sep. 30, 2025

(30) Foreign Application Priority Data
Mar. 30, 2023 (GB) 2304744.2

(51) Int. Cl. H01M 4/36; C23C 24/02; H01M 4/38; H01M 4/40; H01M 10/0525

(52) U.S. Cl. CPC H01M 4/366; C23C 24/02; H01M 4/382; H01M 4/405; H01M 10/0525

(57) ABSTRACT

A method of forming a composite structure comprising an alkali metal or alkali earth metal layer, eg., a lithium layer and a layer comprising a metal other than an alkali metal or alkali earth metal, e.g. silver, on a surface of the alkali or alkali earth metal layer, the method comprising mechanical application of a powder comprising the metal other than an alkali metal or alkali earth metal onto the alkali or alkali earth metal layer surface. The composite structure may be used in a metal battery, e.g., a lithium battery.

### CROSS-REFERENCE TO RELATED APPLICATIONS

This application is a U.S. National Phase Application of PCT International Patent Application No. PCT/EP2024/057469, filed Mar. 20, 2024, which claims priority to GB Patent Application Serial No. 2304744.2, filed Mar. 30, 2023; the disclosure of each of which is incorporated herein by reference in its entirety.

### BACKGROUND

Rechargeable metal batteries, in particular lithium metal batteries, have attracted interest due to their high energy density. However, a drawback of metal batteries is the tendency for metal dendrites to form, limiting the number of useful charge-discharge cycles of the battery and presenting a safety risk.

T. Liu et al, “Lithiophilic Ag/Li composite anodes via a spontaneous reaction for Li nucleation with a reduced barrier”, J. Mater. Chem. A, 2019, 7, 20911-20918 discloses lithiophilic silver/lithium (Ag/Li) composite anodes synthesized via a spontaneous displacement reaction between silver nitrate and Li foil.

S. Tang et al, “A fast ionic conductor and stretchable solid electrolyte artificial interphase layer for Li metal protection in lithium batteries” Journal of Alloys and Compounds, Volume 843, 30 Nov. 2020, 155839 discloses an artificial solid electrolyte interface layer formed by in situ reaction of Cu₃N with Li metal using Cu₃N particles and solid electrolyte

Li-Na Wu et al, “Suppressing lithium dendrite growth by a synergetic effect of uniform nucleation and inhibition”, J. Mater. Chem. A, 2020, 8, 4300-4307 discloses formation of a homogeneous dense layer of Ag—Li alloy seeds with small sizes on a Li metal surface upon introduction of an AgPF₆—LiNO₃ hybrid electrolyte additive introduced into a carbonate electrolyte.

CN110265654 discloses an ultrathin lithium-silver alloy strip for a lithium-ion battery anode. Formation of the alloy strip involves liquefying silver in molten lithium to form a lithium-silver solid solution block which is then rolled into a strip using a roller press.

Z Zuo et al, “Lithiophilic Silver Coating on Lithium Metal Surface for Inhibiting Lithium Dendrites”, https://doi.org/10.3389/fchem.2020.00109 discloses a thin lithiophilic layer of Ag coated on a bare Li surface via a thermal evaporation method.

### SUMMARY

The present disclosure provides a method of forming a composite structure comprising an alkali metal or alkali earth metal layer and a layer comprising a metal other than an alkali metal or alkali earth metal on a surface of the alkali or alkali earth metal layer, the method comprising mechanical application of a powder comprising the metal other than an alkali metal or alkali earth metal onto the alkali or alkali earth metal layer surface.

Optionally, the alkali metal or alkali earth metal layer is a lithium layer.

Optionally, the metal other than an alkali metal or alkali earth metal is silver.

Optionally, the mechanical application is polishing.

Optionally, the powder is applied with a mesh.

Optionally, an alkali oxide layer is removed from the surface of the alkali or alkali earth metal layer prior to mechanical application of the powder.

The present disclosure provides a composite structure obtainable by the method described herein.

The present disclosure provides a composite structure comprising a first layer in direct contact with a second layer wherein the first layer is an alkali metal or alkali earth metal layer and the second layer comprises an alloy of the alkali metal or alkali earth metal and a metal other than the alkali metal or alkali earth metal.

The present disclosure provides an alkali metal or alkali earth metal battery comprising an anode, a cathode, an interfacial layer and an electrolyte disposed between the interfacial layer and cathode wherein the anode and interfacial layer form a composite structure as described herein. Optionally, the electrolyte is a liquid.

By “mechanical application” of a powder to a surface as used herein is meant application to the surface with an application tool in which the powder is pressed against the surface.

### DESCRIPTION OF DRAWINGS

FIG. 1 is a schematic illustration of a secondary metal battery comprising a composite structure as described herein;

FIG. 2A shows Nyquist plots for cells containing comparative disks A-C and a cell containing disk D according to embodiments of the present disclosure;

FIG. 2B shows a magnified region of the Nyquist plot of FIG. 2A;

FIG. 2C shows a further magnified region of the Nyquist plot of FIG. 2B;

FIG. 3 shows illustrative initial and steady state Nyquist plots used in determining lithium transference number (LTN);

FIG. 4 shows illustrative DC measurements of current and voltage vs. time used in determining LTN;

FIG. 5 is a graph of voltage vs. time showing the first two stripping and plating cycles in measurement of the limiting current of cells containing disks A-D;

FIG. 6 is a graph of voltage and current density vs time for a cell containing disk A undergoing stripping and plating cycles;

FIG. 7 is a graph of voltage and current density vs time for a cell containing disk B undergoing stripping and plating cycles;

FIG. 8 is a graph of voltage and current density vs time for a cell containing disk C undergoing stripping and plating cycles; and

FIG. 9 is a graph of voltage and current density vs time for a cell containing disk D undergoing stripping and plating cycles.

The drawings are not drawn to scale. The drawings are some implementations and examples. While the technology is amenable to various modifications and alternative forms, specific embodiments have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

### DETAILED DESCRIPTION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” Additionally, the words “herein,” “above,” “below,” and words of similar import, when used in this application, refer to this application as a whole and not to any particular portions of this application. Where the context permits, words in the Detailed Description using the singular or plural number may also include the plural or singular number respectively. The word “or,” in reference to a list of two or more items, covers all of the following interpretations of the word: any of the items in the list, all of the items in the list, and any combination of the items in the list. References to a layer “over” another layer when used in this application means that the layers may be in direct contact or one or more intervening layers may be present. References to a layer “on” another layer when used in this application means that the layers are in direct contact. References to an element of the Periodic Table include any isotopes of that element.

The teachings of the technology provided herein can be applied to other systems, not necessarily the system described below. The elements and acts of the various examples described below can be combined to provide further implementations of the technology. Some alternative implementations of the technology may include not only additional elements to those implementations noted below, but also may include fewer elements.

These and other changes can be made to the technology in light of the following detailed description. While the description describes certain examples of the technology, and describes the best mode contemplated, no matter how detailed the description appears, the technology can be practiced in many ways. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms.

In the following description, for the purposes of explanation, numerous specific details are set forth in order to provide a thorough understanding of implementations of the disclosed technology. It will be apparent, however, to one skilled in the art that embodiments of the disclosed technology may be practiced without some of these specific details.

### Metal Battery

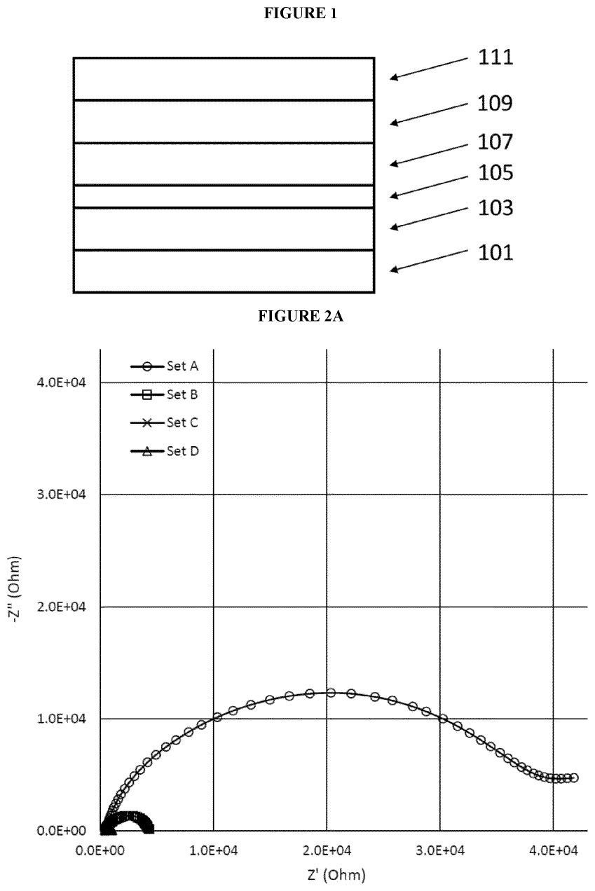

FIG. 1 is a schematic illustration of a secondary metal battery, preferably a secondary alkali metal or alkali earth metal battery and more preferably a secondary lithium, sodium or magnesium metal battery according to some embodiments of the present disclosure.

The battery comprises an anode current collector 101 carrying an anode 103 on a surface thereof; a cathode current collector 111 having a cathode 109 disposed on a surface thereof; an interfacial layer 105 comprising an interfacial metal disposed on a surface of anode 103; and an electrolyte 107 disposed between the interfacial layer 105 and the cathode 109.

The anode 103 is a layer of metal (e.g., lithium) which is formed over the anode current collector during charging of the battery and which is stripped during discharge of the battery.

The interfacial layer 105 comprises an interfacial metal which is a metal other than an alkali metal or alkali earth metal, preferably gold, aluminium, yttrium, zinc, tin and silver. Silver is preferred. Without wishing to be bound by any theory, it is believed that the interfacial layer comprises or consists of an alloy of the anode metal (e.g., lithium) and the interfacial metal.

The present inventors have surprisingly found that an interfacial layer as described herein can provide protection against electrical shorting whilst maintaining a high current density.

The cathode may be selected from any cathode known to the skilled person.

The anode and cathode current collectors may be any suitable conductive material known to the skilled person, e.g., one or more layers of metal or metal alloy such as aluminium or copper.

A battery may be formed by providing an electrolyte as described herein on a surface of one of an anode interfacial layer carried on a surface of a metal anode and a cathode and providing the other of an anode and cathode, and associated current collector, over the electrolyte.

FIG. 1 illustrates a battery in which the anode interfacial layer and cathode are separated by a single layer only comprising or consisting of the electrolyte, for example a separator comprising the electrolyte. In other embodiments, one or more further layers may be disposed between the anode interfacial layer and the cathode.

A battery as described herein or a battery pack comprising a plurality of batteries as described herein may be used, without limitation, to power electric vehicles or stationary objects.

### Interfacial Metal Powder Formation

The interfacial metal powder, which is preferably silver powder, may be formed by reduction of the interfacial metal cation in a solution of an interfacial metal salt in the presence of a reducing agent. In some embodiments, the reducing agent is an alkali metal. The interfacial metal salt solution is preferably a saturated solution. The alkali metal may be provided in any form, for example a foil or a powder.

The metal powder may consist solely of the interfacial metal, i.e., a metal other than an alkali or alkali earth metal. In some embodiments, the metal powder may further comprise an alkali or alkali earth metal, for example if an alkali metal is used in reduction of the interfacial metal cation.

Any suitable solvent may be used, preferably an aprotic organic solvent. Exemplary solvents include, without limitation, C₂₋₁₀ alkylene carbonates and di(C₁₋₁₀ alkyl) carbonates, for example propylene carbonate, ethylene carbonate, dimethyl carbonate and diethyl carbonate.

### Composite Structure

A composite structure as described herein comprises an alkali or alkali earth metal layer and an interfacial layer in direct contact with a surface of alkali metal layer. The composite structure may be formed by mechanical application of a powder comprising or consisting of the interfacial metal to a surface of an alkali or alkali earth metal layer.

The powder is mechanically applied using an application tool which presses the powder against the alkali metal surface. In preferred embodiments, the mechanical tool is moved laterally across the alkali metal surface. A preferred mechanical application method is polishing. A preferred mechanical application tool is a plastic mesh.

The present inventors have unexpectedly found that mechanical application of an interfacial metal powder to an alkali metal surface as described herein can result in a film which is smoother than that obtained by reduction of a salt of the same metal onto a surface of the alkali metal. The mechanical application as described herein also allows control over the thickness of the film containing the transition metal, does not require use of an evaporation or sputtering tool and does not carry any of the safety risks associated with a solution on the surface of an alkali metal.

Without wishing to be bound by any theory, it is believed that during the mechanical application the interfacial metal powder alloys with the alkali metal or alkali earth metal at the surface of the alkali or alkali earth metal layer.

Alkali or alkali earth metals typically have an oxide layer at a surface thereof. Again without wishing to be bound by any theory, it is believed that this oxide layer is abraded by the powder and/or by the mechanical application tool during mechanical application of the powder as described herein, with the effect that surface of the alkali or alkali earth metal layer is in direct contact with at least some of the surface of the interfacial layer formed following mechanical application of the interfacial metal.

The interfacial layer may provide stability against degradation in air as compared to a bare alkali or alkali earth metal film. Accordingly, a composite structure as described herein may be used in construction of a secondary metal battery cell in an oxygen-containing environment, for example a dry room.

The present inventors have further found that the interfacial layer as described herein may be hydrophobic, which may prevent degradation of the anode during assembly of a cell containing the composite anode.

The alkali metal layer may be provided in any form, for example a foil or disk. If an oxide layer is present at the surface of the alkali metal then this may removed by any method known to the skilled person, for example polishing, before the powder is mechanically applied to the alkali metal surface. Polishing may be with a plastic mesh. This preliminary oxide layer removal may result in an alkali metal layer having an oxide layer of reduced thickness. This reduced thickness oxide layer may be partially or completely abraded away upon mechanical application of the interfacial metal powder.

### Electrolyte

In some embodiments, the electrolyte is a liquid absorbed in a porous separator. The liquid may be an ionic liquid.

In some embodiments, the electrolyte is a solid electrolyte or a gel electrolyte, in which case a porous separator may or may not be present. The electrolyte may be a solid polymer electrolyte.

The electrolyte may comprise an alkali metal salt in a solvent and/or an ion-conducting polymer.

Exemplary electrolyte solvents include, without limitation, C₂₋₁₀ alkylene carbonates, di(C₁₋₁₀ alkyl) carbonates, for example propylene carbonate, ethylene carbonate, dimethyl carbonate, diethyl carbonate; linear, branched or cyclic compounds containing two or more ether groups, for example 1,3-dioxolane, 2,5dimethoxy tetrahydrofuran, glyme (dimethoxyethane), diglyme, triglyme and tetraglyme; cyclic lactones and mixtures thereof.

Ion-conducting polymers include, without limitation: poly(alkylene oxide), for example poly(ethylene oxide) and poly(propylene oxide); and fluorinated polymers such as PVDF, PVDF-HFP; PMMA; polyacrylonitrile; polycarbonate; polyethylene; polypropylene; poly(vinyl methyl ketone); polyvinylpyrrolidone; polyether ether ketone; polyisoprene; polybutadiene; polystyrene-block-polyisoprene-block-polystyrene; poly(l-vinylpyrrolidone-co-vinyl acetate); polystyrene-block-polybutadiene-block-polystyrene; polystyrene-block-poly(ethylene oxide)-block-polystyrene; co-polymer and mixtures thereof.

The ion-conducting polymer is suitably a neutral polymer, i.e., not a polymer substituted with ionic groups, and in particular is suitably not a single-ion conducting polymer comprising anionic groups.

The alkali metal salt may be, for example, M⁺PF₆₋, M⁺BF₄₋, M⁺ClO₄⁻, alkali metal bis(oxalato)borate (M⁺BOB⁻), alkali metal bis(trifluoromethanesulfonyl)imide (M⁺TSFI⁻) wherein M⁺ is an alkali metal cation preferably a lithium cation, or a compound of formula (I):

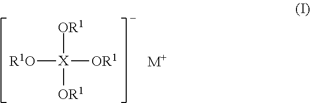

wherein:
X is Al or B;
M⁺ is an alkali metal cation, preferably Li⁺; and
R¹ in each occurrence is independently a substituent wherein two R¹ groups may be linked to form a ring.

Preferably, each R¹ is independently selected from:
C₁₋₂₀ alkyl wherein one or more non-adjacent C atoms other than the C atom directly bound to O of the borate or aluminate may be replaced with O and one or more H atoms may be replaced with F;
an optionally substituted C₆₋₂₀ aryl; and
C₁₋₂₀ alkylene-C₆₋₂₀ aryl wherein one or more non-adjacent C atoms of the C₁₋₂₀ alkylene other than the C atom bound to O of the borate may be replaced with O and one or more H atoms of the C₁₋₂₀ alkylene may be replaced with F, and the C₆₋₂₀ aryl may be unsubstituted or substituted.

Where present, substituents of the C₆₋₂₀ aryl are preferably and independently selected from substituents R⁵ wherein R⁵ in each occurrence is independently selected from the group consisting of F and C₁₋₁₂ alkyl wherein one or more non-adjacent, non-terminal C atoms of the C₁₋₁₂ alkyl may be replaced with O, S, NR⁴, CO COO or CONR⁴ wherein R⁴ in each occurrence is independently a C₁₋₁₂ hydrocarbyl group, and one or more H atoms of the C₁₋₁₂ alkyl group may be replaced with F.

By “non-terminal C atom” of an alkyl chain as used herein is meant the methyl group at the chain end of a linear alkyl chain or each one of the methyl groups at the chain ends of a branched alkyl group.

A C₁₋₁₂ hydrocarbyl group as described anywhere herein is preferably selected from C₁₋₁₂ alkyl; phenyl; and phenyl substituted with one or more C₁₋₆ alkyl groups.

In the case where none of the R¹ groups are linked, preferably each R¹ independently in each occurrence is a C₁₋₂₀ alkyl group wherein one or more non-adjacent C atoms of the alkyl group may be replaced with O and one or more H atoms of the alkyl group may be replaced with F.

In some embodiments, two pairs of R¹ groups are linked and the compound of formula (I) has formula (II):

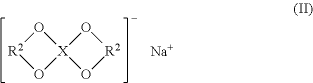

R² in each occurrence is independently a divalent organic group.

Preferably, R² is selected from:
unsubstituted or substituted C₆₋₂₀ arylene;
unsubstituted or substituted C₁₋₂₀ alkylene wherein one or more non-adjacent C atoms other than the C atoms directly bound to O of the borate or aluminate may be replaced with O and one or more H atoms may be replaced with F; and
C₁₋₂₀-alkylene-C₆₋₂₀ arylene wherein one or more non-adjacent C atoms of the C₁₋₂₀ alkylene other than the C atoms bound to O of the borate or aluminate may be replaced with O, the C₁₋₂₀-alkylene is unsubstituted or substituted; and the C₆₋₂₀ arylene is substituted or unsubstituted.

The C₆₋₂₀ arylene may be unsubstituted or substituted with one or more substituents. Preferred substituents, where present, are selected from R⁵ as described above.

R² is preferably selected from: Ar¹ wherein Ar¹ in each occurrence is independent an optionally substituted C₆₋₂₀ arylene group, e.g. 1,2-phenylene, which may be unsubstituted or substituted with one or more substituents; a bi-arylene group of formula Ar¹-Ar¹, for example 2,2′-linked biphenylene which may be unsubstituted or substituted with one or more substituents; ethylene; propylene; and a group of formula (III):

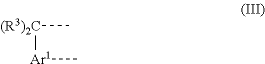

wherein R³ in each occurrence is H, F or a C₁₋₆ alkyl in which one or more H atoms may be replaced with F; and Ar¹ is a C₆₋₂₀ arylene group, preferably unsubstituted or substituted 1,2-phenylene.

In a preferred embodiment, at least one R³, optionally each R³, is a C₁₋₆ perfluoroalkyl group.

Preferably, each Ar¹ of formula (I) is phenylene, more preferably a 1,2-linked phenylene which is unsubstituted or substituted with one or more substituents.

Where present, substituents of Ar¹ are preferably and independently selected from R⁵ as described above

The compound of formula (I) may comprise a solvated M+ cation.

Optionally, the electrolyte as present in a battery contains no more than 10 solvent molecules per M+ cation. The solvent/M+ ratio may be as determined from a 1H NMR spectrum of the electrolyte prior to its incorporation into a battery.

### EXAMPLES

Lithium batteries were formed using comparative lithium disks denoted herein as disks A, B and C and a composite disk according to an embodiment of the present disclosure, denoted herein as disk D.

### Comparative Disk Set A

The Li disks of Set A were used as received from Cambridge Energy Solutions.

### Comparative Disk Set B

Commercial lithium disk A was polished using ETFE mesh (purchased from Plastok Associates Ltd, mesh opening 150 microns, open area 36%) inside an argon glovebox (MBraun). This was done to remove the native lithium oxide layer on the surface of Disk A.

### Comparative Disk Set C

A room temperature-saturated solution of silver nitrate (between 0.01 M and 0.05 M) was prepared, with dimethyl carbonate as the solvent.

Polished Disk B with freshly exposed metallic lithium was submerged in the AgNO₃ solution in a Petri dish for about 3 hours. After this immersion step, the disks were removed and left to dry at room temperature for 15 minutes to give a composite structure of a lithium layer and a silver layer.

All of the processing steps above were performed in an Argon glove box.

The silver layer was found to be relatively thick and porous.

### Exemplary Disk Set D

A saturated solution of silver nitrate in dimethyl carbonate was reduced with small pieces of metallic lithium foil, by stirring overnight using a magnetic stirrer bar at RPM>900. The reaction resulted in the formation of a finely dispersed, grey-black powder that was collected and dried in a Petri dish at room temperature.

The ETFE mesh was dipped into the dried grey-black powder in the Petri dish and was gently polished onto the surfaces of Comparative Disk B without native oxide layer to form a smooth, thin layer. This treatment resulted in a colour change in the grey-black silver powder which is attributed to the formation of silver-lithium alloy on the surface of the lithium disks.

### Cell General Method

Symmetrical 2032-type coin cells were fabricated in a rigorously dry and oxygen-free Argon gas-filled MBraun glovebox using casings purchased from Cambridge Energy Solutions.

A stainless-steel spacer was inserted in a coin cell bottom, followed by one of Comparative Disks A-C or Exemplary Disk D and a fluoro-silicone stencil (purchased from Silex Silicones). The stencil was shaped as a disk of 15.5 mm diameter, with a circular hole of 5 mm diameter cut in its middle (the thickness of the stencil in the crimped cell was 360 μm). The hole was filled with 30 μl of an electrolyte solution of Lithium Salt 1 in propylene carbonate (9 moles of propylene carbonate per 1 mole of Li+).

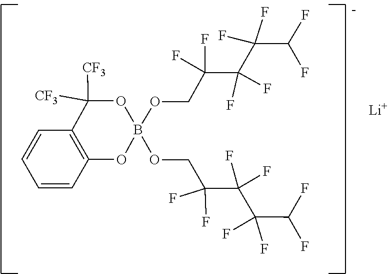

The same one of Comparative Disks A-C and Exemplary Disk D was placed on top of the stencil, followed by a stainless-steel spacer, a wave spring and a coin cell top. Finally, the coin cell was crimped.

In the case of the cells containing Comparative Disk B, the stencil containing the electrolyte was sandwiched between the lithium disks with the exposed lithium surface of both the top and bottom disks facing the stencil and electrolyte.

In the case of the cells containing Comparative Disk C, the stencil containing the electrolyte was sandwiched between the lithium/silver composite disks with the silver layer of both the top and bottom disks facing the stencil and electrolyte.

In the case of the cells containing Exemplary Disk D, the stencil containing the electrolyte was sandwiched between the lithium/Li—Ag alloy composite disks with the alloy layer of both the top and bottom disks facing the stencil and electrolyte.

### Results

Electrochemical Impedance Spectroscopy (EIS) measurements were conducted at room temperature. Impedances were taken over a frequency range of 1 Hz to 1 MHz, with an amplitude of 5 mV.

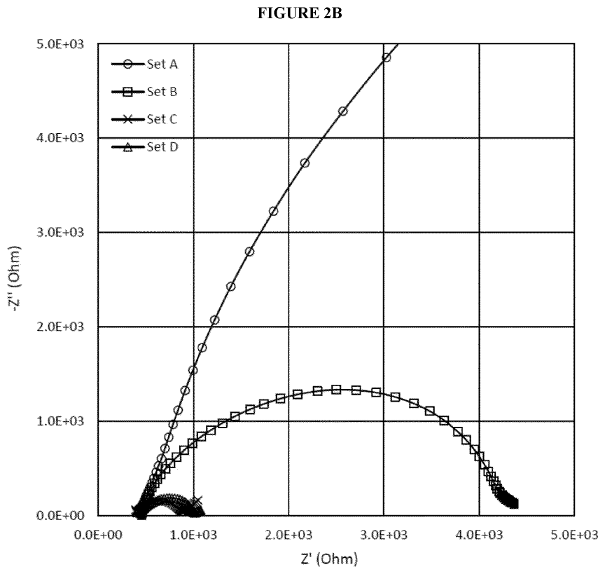

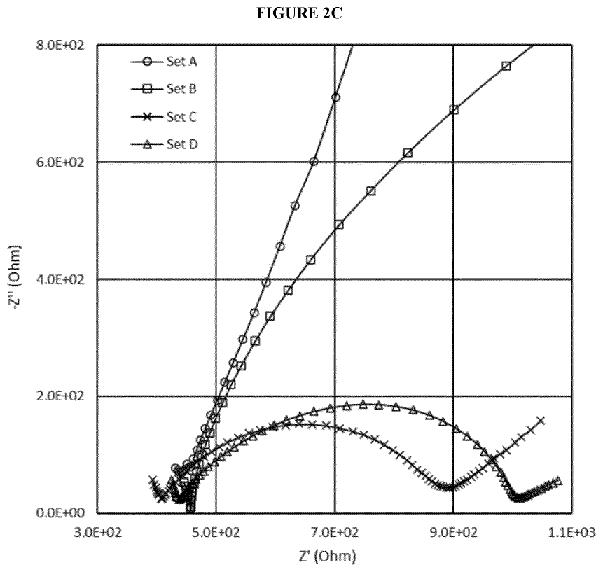

Nyquist plots for cells containing Sets A-D are shown in FIG. 2A, with magnification in FIGS. 2B and 2C.

Each cell was fitted with a series of three parallel R-CPE circuits. The central R-CPE circuit was taken as the impedance at the surface of the lithium. Results are given in Table 1.

| | Li surface |
|---|---|
| Cell | impedance (Ohms) |
| Set A | 37210 |
| Set B | 3780 |
| Set C | 470 |
| Set D | 600 |

As shown in Table 1, the presence of silver in Sets C and D results in much lower surface impedances than either Set A or Set B.

Lithium transference number (LTN) was measured according to Evans's method (J. Evans et al., POLYMER, 1987, Vol 28), using the 2032-type coin cell described above.

Devices were left resting overnight for about 19 hours before performing the LTN measurement, in order to ensure stabilisation of the interfaces between the electrolytes and the lithium disks or composite disks.

After resting:
1. A first EIS spectrum was measured.
2. This was followed by a DC current measurement (the applied constant voltage is tuned individually for each cell in order to achieve an initial current of about 0.5 ρA. The measurement was terminated as soon as the current had decreased to a steady state.
3. The sequence was then finished with a second EIS measurement.

The EIS measurements were conducted at room temperature. The EIS measurements were taken over a frequency range of 1 Hz to 1 MHz, with an amplitude of 5 mV.

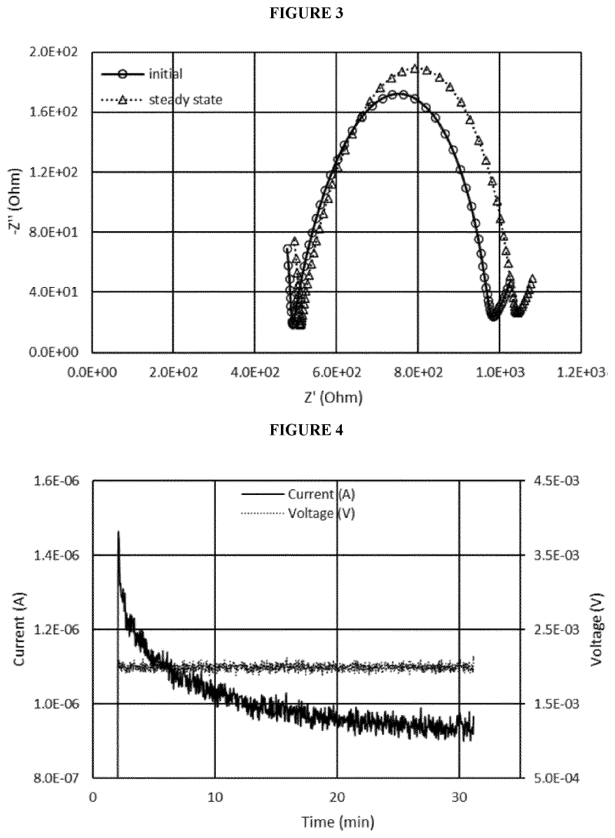

The LTN values were calculated according to the following formula, based on the model developed by Evans et al.

$$LTN = \frac{{I}^{s} ( Δ V - {I}^{0} {R}^{0} )}{{I}^{0} ( Δ V - {I}^{s} {R}^{s} )}$$

where (referring to the illustrative Nyquist plot shown in FIG. 3 and the illustrative current and voltage vs time plot shown in FIG. 4):
1. R⁰ is the initial impedance taken from the first EIS spectrum (determined by estimating the intercept on the x-axis of the Nyquist plot of the second semicircle (right hand side)).
2. R^{s} is the steady state impedance taken from the second EIS after a DC bias was applied (determined by estimating the intercept on the x-axis of the Nyquist plot of the second semicircle (right hand side)).
3. I⁰ is the initial current taken when the voltage is stepped to set value.
4. I^{s} is the steady state current taken at the end of the DC measurement.

LTN values are given in Table 2. Results are similar except for Set C.

TABLE 2

| | | Standard |
|---|---|---|
| Cell | LTN | deviation |
| Set A | 0.56 | 0.28 |
| Set B | 0.50 | 0.21 |
| Set C | 0.23 | 0.11 |
| Set D | 0.54 | 0.03 |

The limiting current density of the cells was measured using an Arbin Instruments battery testing system.

The limiting current density is the highest unidirectional current density that a given electrolyte material can sustain over extended periods of time. It is determined by measuring the current density as a function of time, during successive plating and stripping cycles at stepwise increased voltages.

The Lithium plating and stripping cycles were carried out as follows (FIG. 5):
1. Application of an initial stripping voltage of 50 mV to the working electrode (referred to hereafter as “stripping”) for 2 hours, followed by
2. Application of a constant voltage of 10 mV for 10 minutes, followed by
3. Application of a constant voltage of −10 mV for 10 minutes (steps (2) and (3) are referred to as “resting”)
4. Application of an initial plating voltage of −50 mV to the working electrode (referred to hereafter as “plating”) for 2 hours.
5. Following this, steps (1) to (4) were repeated several times, with the applied “stripping” & “plating” voltages increasing by 50 mV during each step. The “resting” voltages remained unchanged.
6. The measurement was stopped once the “stripping” & “plating” voltages reached+/−0.6V (respectively).

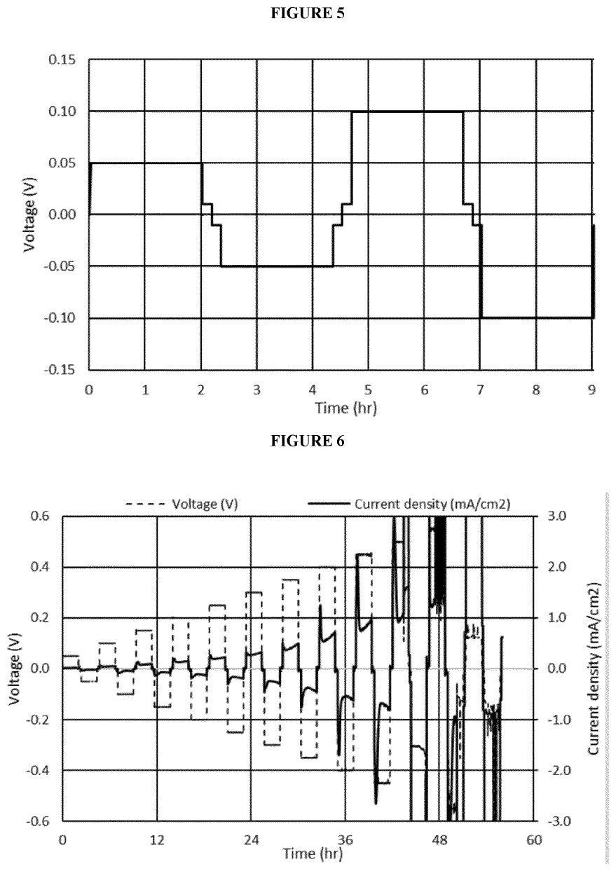

The results of the limiting current measurements for coin cells with cells containing disks of Sets A-D are shown in FIGS. 6 to 9 respectively.

With reference to FIG. 6, electrical shorts started to appear in the cell containing Set A (untreated lithium) at the 0.5V voltage step.

Up to 0.5 V, the current levels increase with each voltage increase indicating that the limiting current had not been reached by the time electrical shorts appeared at 0.5V.

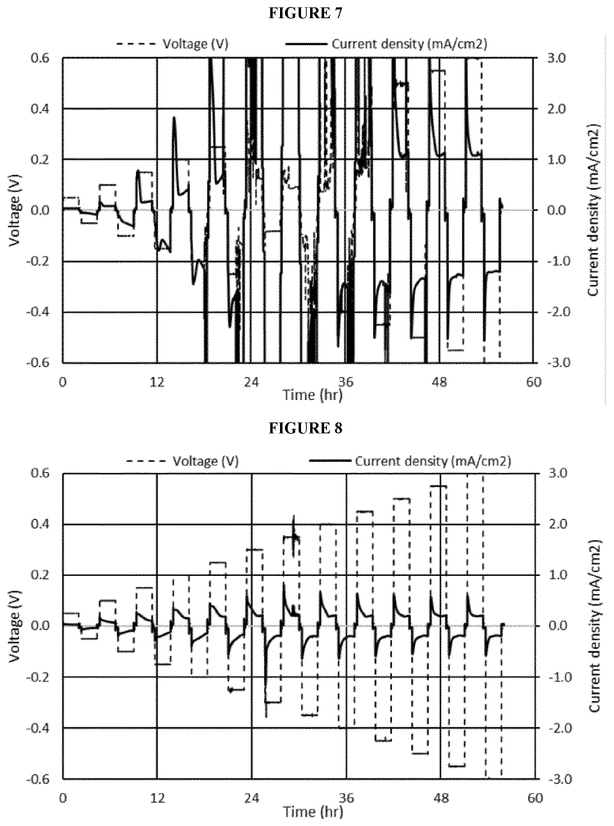

With reference to FIG. 7, for cells containing Set B (polished lithium disks) transient electrical shorts started to appear at 0.3 V, much earlier than in the case of cells with Set A (untreated lithium disks). However, shorting was transient, and the current voltage characteristics stabilized at around 0.5 V, with the limiting current density stabilizing at around 1 mAcm⁻².

With reference to FIG. 8, for cells containing Set C no electrical shorting was absorbed which is attributed to the presence of the thick, porous silver surface layer preventing dendrite formation. However, the current density was drastically reduced from 1 mA cm⁻² observed for Set B to 0.2 mA cm⁻². Without wishing to be bound by theory, it is believed that the diffusion of Li cations into and out of the electrolyte in deep pores within the thick silver surface layer may limit the rate of ionic charge transfer between the bulk electrolyte and the electrodes.

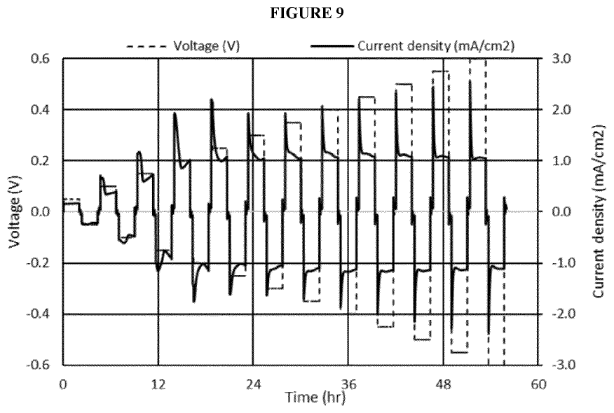

With reference to FIG. 9, for cells containing Set D no electrical shorting was observed, which is attributed to silver at the anode/electrolyte interface preventing dendrite formation.

However, in contrast to the thick Ag layers of Set C, the thin, smooth Ag layers of Set D maintain the limiting current density at 1 mA cm⁻². This is similar to the values found with freshly polished lithium (Set B), but without the electrical shorts.

1. A method of forming a composite structure comprising an alkali metal layer and a layer comprising silver metal on a surface of the alkali metal layer, the method comprising mechanical application of a powder comprising the silver metal onto the alkali earth metal layer surface.

2. The method according to claim 1 wherein the alkali metal layer is a lithium layer.

3. (canceled)

4. The method according to claim 1 wherein the mechanical application is polishing.

5. The method according to claim 1 wherein the powder is applied with a mesh.

6. The method according to claim 1 wherein an alkali oxide layer is removed from the surface of the alkali or alkali earth metal layer prior to mechanical application of the powder.

7. A composite structure obtainable by the method according to claim 1.

8. A composite structure comprising a first layer in direct contact with a second layer wherein the first layer is an alkali metal layer and the second layer comprises an alloy of the alkali metal and silver metal.

9. An alkali metal battery comprising an anode, a cathode, an interfacial layer and an electrolyte disposed between the interfacial layer and cathode wherein the anode and interfacial layer form a composite structure according to claim 7.

10. The alkali metal battery according to claim 9 wherein the electrolyte is a liquid.

11. An alkali metal battery comprising an anode, a cathode, an interfacial layer and an electrolyte disposed between the interfacial layer and cathode wherein the anode and interfacial layer form a composite structure according to claim 8.
